(19) United States
(12) Patent Application Publication
(10) Pub. No.: US 2026/0192177 A1
(43) Pub. Date: Jul. 9, 2026

(54) TASK TRAINING SYSTEM WITH HOLOGRAPHIC INSTRUCTION

(71) Applicant: Raymond BROTHERS, Beverly Hills, CA (US)

(72) Inventor: Raymond BROTHERS, Beverly Hills, CA (US)

(21) Appl. No.: 19/444,614

(22) Filed: Jan. 9, 2026

Related U.S. Application Data
(60) Provisional application No. 63/743,556, filed on Jan. 9, 2025.

(51) Int. Cl. A63B 71/06

(52) U.S. Cl. CPC A63B 71/0622; A63B 2071/0638; A63B 2220/836

(57) ABSTRACT

A task training system may detect a first condition of a user with a sensor array with the sensor array connected to a computing device. The computing device may generate a first training content in response to the detected first condition and display the first training content to the user. A reaction of the user may be identified by with the sensor array in response to the first training content to allow the computing device to determine a mismatch of the reaction to a predetermined activity parameter. The computing device may then generate and display to the user a second training content in response to the mismatch. A second condition of the user may be detected with the sensor array and confirmed, with the computing device, that the second training content matches the predetermined activity parameter.

### CROSS REFERENCE TO RELATED APPLICATION

This application claims the benefit of U.S. Provisional Application No. 63/743,556 which was filed on Jan. 9, 2025, and is currently pending, the disclosure of which is hereby incorporated by reference herein in its entirety.

### FIELD

This disclosure relates generally to training systems and, more particularly, to sensor-based intelligence systems used to train a user with holographic and other visual communications to increase proficiency in training and completing one or more tasks.

### BACKGROUND

The training of assorted human activity may be conducted via coaching. By having another human evaluate activity, such as posture, movement, position, and action, an individual may receive feedback, such as instruction, verbal direction, and other communications, that increases proficiency, accuracy, and effectiveness of performing a task. For instance, a sports coach may provide feedback during a drill or event that verbally instructs an athlete how to perform an activity, such as throwing a ball or swinging a bat. In another instance, an instructor may provide feedback to a trainee by visually showing how to perform an activity.

With conventional coaching, the ability, skill, and availability of a person correspond with the quality, and effectiveness, of feedback provided to an individual. Consequently, training an activity may be dependent on the presence, evaluation skill, and communication skill of an instructor, trainer, or coach. Hence, there is a continued interest in systems that decrease the dependence on other human participation in training activity as well as increase the effectiveness of training communications.

### SUMMARY

Embodiments of the present disclosure are generally directed to training systems, such as but not limited to, task-specific training based on sensed operator activity.

In accordance with some embodiments, a task training system may detect a first condition of a user with a sensor array with the sensor array connected to a computing device. The computing device may generate a first training content in response to the detected first condition and display the first training content to the user. A reaction of the user may be identified by with the sensor array in response to the first training content to allow the computing device to determine a mismatch of the reaction to a predetermined activity parameter. The computing device may then generate and display to the user a second training content in response to the mismatch. A second condition of the user may be detected with the sensor array and confirmed, with the computing device, that the second training content matches the predetermined activity parameter.

A task training system, in accordance with other embodiments, may have a sensor array connected to a computing device and worn by a user. A first content display may be connected to the computing device and worn by the user. The computing device may detect a first condition of the user with the sensor array, generate a first training content in response to the detected first condition, and display the first training content to the user with the first content display. The first content display may display a second training content generated by the computing device to the user in response to a reaction of the user identified by the sensor array. The second training content may differ from the first training content and may be generated by the computing device in response to a determination, by the computing device, that the reaction of the user failed to match a predetermined activity parameter. The computing device may confirm a second condition of the user, detected by the sensor array, conforms to the predetermined activity parameter in response to the display of the second training content.

In some aspects, the first condition may be conducting an action associated with a sport. The first training content, in other aspects, may be displayed to the user via a holographic projector. The second training content may be different than the first training content, in various aspects. The second training content, in some embodiments, may be displayed to the user differently than the first training content. In other embodiments, the second training content may have a different formatting than the first training content. The second training content may be displayed at a different position relative to the user than the first training content, in various embodiments.

Aspects of the second training content may be animated and the first training content may be static. The second training content may be displayed at a slower speed than the first training content, in some aspects. The second training content, in other aspects, may be generated in response to recognizing the user conducting a known task. Embodiments of the second training content may be selected from a communication strategy created by the computing device and the communication strategy may prescribe predetermined training content responses to user conditions detected by the sensor array. The predetermined training content responses, in some embodiments, may change the first training content to the second training content to increase a proficiency in the known task.

In some aspects, a task training system may evaluate, with the computing device, an effectiveness of the first training content in completing the known task and determine a failure of the first training content to achieve an operational milestone associated with the known task before altering, with the computing device, the first training content to the second training content to increase proficiency of the user in completing the known task. Other aspects may arrange the sensor array with a first sensor attached to a head of the user and a second sensor attached to a body of the user. The sensor array, in some embodiments, may have a first sensor that may move with the user and a second sensor that may remain stationary with respect to the user.

Embodiments of the computing device may have a processor that may generate the second training content in response to a calculation of an effectiveness of the first training content in causing the user to match the predetermined activity parameter and may alter the first training content to the second training content to increase proficiency of the user in repeatedly completing the predetermined activity parameter. A task training system may have a second content display connected to the computing device that may display information to the user differently than the first content display with the first content display being a holographic projector and the second content display being an augmented reality headset worn by the user, in accordance with some aspects.

In some aspects, a task training system may have a headband attached to a user with the headband having at least one sensor. A condition of the user may be detected with at least one sensor prior to generation of a communication strategy in response to the detected condition that prescribes visual content to be displayed to the user in response to an operational trigger. The sensing of the user meeting the operational trigger may prompt the choosing of a first communication mode for the visual content prescribed by the communication strategy and the displaying of the visual content prescribed by the communication strategy with the chosen first communication mode. The effectiveness of the visual content in completing a task may be evaluated to allow for the determination that the visual content fails to achieve an operational milestone associated with the task. The visual content may then be altered to increase proficiency of the user in completing the task and subsequently displayed to the user with a second communication mode

Other embodiments of a training system may provide a device that has a headband into which at least one sensor and computing device are integrated. The headband may be attached to a user where a sensor may detect a condition of the user. The computing device may have circuitry operable to generate a communication strategy in response to the detected condition with the communication strategy prescribing visual content to be displayed to the user in response to an operational trigger. The computing device may sense the user meeting the operational trigger and choose a first communication mode for the visual content that is prescribed by the communication strategy. The computing device may display visual content prescribed by the communication strategy with the chosen first communication mode then evaluate an effectiveness of the visual content in completing a task. The computing device may determine a failure of the visual content to achieve an operational milestone associated with the task before altering the visual content to increase proficiency of the user in completing the task, which may be displayed to the user with a second communication mode, as directed by the computing device.

These and other features which characterize various embodiments of the present disclosure can be understood in view of the following detailed discussion and the accompanying drawings.

### BRIEF DESCRIPTION OF THE DRAWINGS

FIG. 1 is a functional block representation of a training environment in which various embodiments of the present disclosure can be practiced.

FIG. 2 is a block representation of a training assembly that may be utilized in the training environment of FIG. 1 in accordance with some embodiments.

FIG. 3 is a block representation of a training system that may be employed in the training environment of FIG. 1 in accordance with assorted embodiments.

FIG. 4 is a block representation of a training system configured and operated in accordance with various embodiments.

FIG. 5 is a block representation of a training system which arranged in accordance with some embodiments.

FIG. 6 is a flowchart depicting example operation of a training system conducted in accordance with various embodiments.

FIG. 7 is a flowchart depicting function of an example training system executed in accordance with assorted embodiments.

### DETAILED DESCRIPTION

Embodiments of a training system may provide autonomous evaluation and instruction of a trainee to increase proficiency at completing one or more tasks. Through the use of sensor data to determine assorted aspects of a trainee, such as biometrics, mental processing, and physical capabilities, intelligence may generate a strategy for increasing the trainee's ability to successfully perform a task. A task training strategy may, in some embodiments, involve intelligently choosing what drills, actions, and positions for a trainee to perform as well as how to convey such information. Accordingly, training system embodiments may intelligently interpret sensed trainee physical, and mental, biometrics to provide training instructions communicated to increase training efficiency and effectiveness.

It is contemplated that training a task may be variable and dependent on the presence, and skill, of others. While some automated teaching systems may communicate training instructions, such communications are not customized to the trainee or how effective a training session is progressing. For instance, communicating ideal task instructions to a trainee in a static manner may not be efficiently understood, or implemented, to constructively progress towards completion of the task and/or proficiency of the trainee on completing the task again. Accordingly, embodiments of a training system provide hardware that translates sensor data into customized training actions that are conveyed to a trainee in a manner that increases the chance of training actions being understood and implemented.

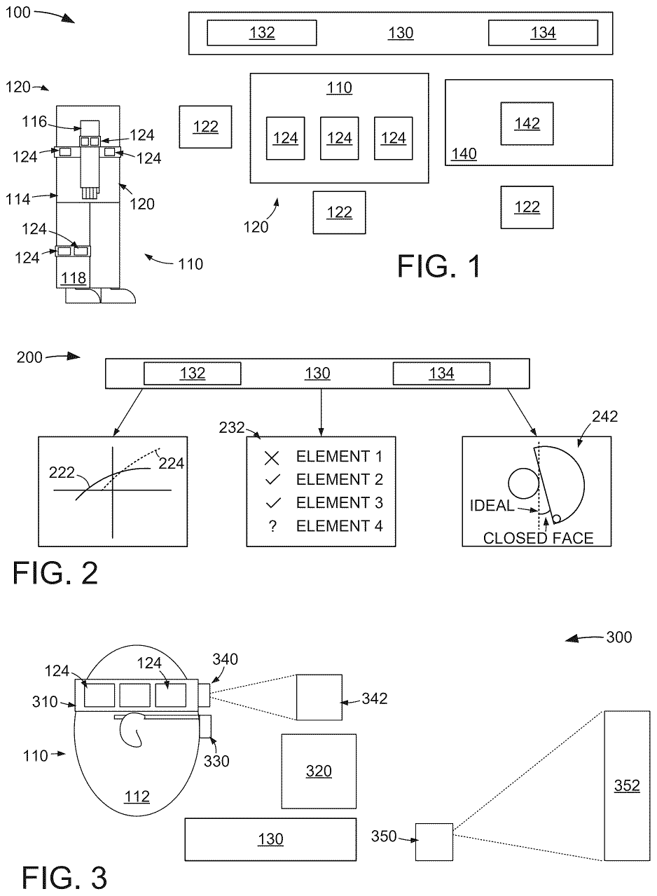

An example training environment 100 is conveyed as a block representation in FIG. 1. Assorted embodiments of a training system may be practiced in the training environment 100 with one or more trainees 110 participating in poses, movements, and actions that are evaluated by a network of sensors 120. It is noted that any number, and type, of sensor 120 may be positioned on, or around, a trainee 110 to analyze at least biometric aspects of the trainee 110, such as physical, mental, and environmental metrics. Some embodiments of a training environment 100 employs stationary sensors 122, such as cameras, LiDAR, and acoustic detectors, along with dynamic sensors 124 located on a trainee 110, such as accelerometers, force, and ultrasonic detectors.

The ability to employ a variety of different sensors 120 concurrently allows for the collection of a diverse range of data, which can involve environmental data, such as temperature, humidity, and wind, as well as biometric data about the trainee 110, such as heart rate, body temperature, and brain activity. Some embodiments may further collect data, with one or more sensors 120, about the activity of a trainee 110, such as body position, force applied, and plane of movement. It is noted that selected sensors 120 may be configured to collect data for a selected amount of time, such as one second, one minute, or thirty seconds, while other sensors 120 collect data in response to a trigger, such as a sensed data from a separate sensor 122/124 reaching a predetermined threshold.

With the detection of redundant, collective, and individual measurements and data from the assorted sensors 120, a variety of different statistical and comparative analysis can be conducted to interpret how the trainee 110 is acting and performing at selected instances as well as over time. That is, the use of the various sensors 120 provide data that may provide mathematical understanding of how a trainee 110 is performing compared to a standard, which may be utilized to identify tendencies and cyclic behaviors of the trainee 110.

However, the interpretation of the detected information from one or more sensors 120, particularly when a variety of different sensors 122/124 are concurrently providing data, may be difficult and/or inefficient to interpret by the trainee 110 or other human, such as a coach, trainer, or advisor. To address the interpretation of the sensed information, one or more computing devices 130 may be employed to collect, interpret, transmit, and store data associated with at least the trainee's activity over time. It is noted that the assorted sensors 120 may be connected to the computing devices 130 in a variety of manners, such as wired or wireless signal pathways as well as local transfer from mobile memory.

Despite the incorporation of computer processing and memory with one or more computing devices 130, the translation of collected information from sensors 120 into identified tendencies, behaviors, and deviations from ideal performance may be inefficient. One or more trainees 110 may participate in the training environment 100 and conduct any number, and type, of actions in the performance of an activity, such as a sport or a non-porting task. The sport can include, but is not limited to, football, basketball, golf, tennis, pickleball, weightlifting, dancing, karate, or other sporting event. The non-sporting task can include, but is not limited to, medical procedures, field work, and equipment operation. Non-limiting examples of medical procedures includes physical therapy, emergency trauma response, surgical operations, treating conditions and diseases, and administering palliative care.

In the completion of some sporting, and non-sporting, tasks, a trainee 110 may engage an apparatus 140, such as a goal, hoop, net, tool, or control. Such task apparatus 140 may have multiple sub-components 142, such as a backboard, bat, secondary control, or separate tool. A trainee 110 may be monitored by any number, and type, of sensors 120 that utilizes, for instance, optical, acoustic, mechanical, or other detectors. Such monitoring may detect and/or record numerous concurrent biometric conditions for a trainee 110, such as movement, mental state, stress, position, velocity, acceleration, VO₂ Max, and heart rate, as well as environmental conditions, such as wind speed, wind direction, temperature, humidity, and pressure.

In some non-limiting examples of non-sporting tasks, field work and equipment operations may be sensed, evaluated, and trained with sensors 120 and computing device 130. For instance, a mechanical tool, such as a wrench or drill, may be an apparatus 140 that is recognized and trained for use within the training environment 100. Another non-limiting example may recognize buttons, knobs, levers, and other controls that may be manipulated by a trainee 110, in accordance with guidance and training provided by the computing device 130 to complete one or more tasks, such as articulating equipment, responding to operating conditions, or accomplishing a result.

Various embodiments connect the assorted sensors 120 in an environment 100 to the computing device 130 that may process, store, and compute signals to determine the activity. The computing device 130 may utilize a processor 132, such as a microcontroller or programmable circuitry, and memory 134, such as volatile, non-volatile, solid-state, magnetic, and tape data storage, to interpret sensed data into athletic information about the trainee 110 and/or athletic activity.

A sensor 120 may be positioned in a variety of positions in the training environment 100. For instance, mounted sensors 122 may be secured with a stand, mount, or other physical structure anywhere around a room, field, course, or court. In some embodiments, an array of sensors 120 is positioned proximal the trainee 110. As shown, a sensor array 120 may be specifically configured to attach a sensor 124 to a designated portion of the trainee 110, such as a head 112, as shown in FIG. 3, torso 114, arm 116, or leg 118. By providing one or more sensors 124 on a wearable band, strap, harness, or other wearable garment, various aspects of trainee 110 activity and position may be accurately and efficiently sensed.

Despite the incorporation of computer processing and memory with one or more computing devices 130, the translation of collected information from sensors 120 into an understanding of the biometrical state of the trainee 110 may be relatively inefficient and inaccurate. That is, sensed information may be ignored, overemphasized, and/or misused to determine how a trainee 110 is mentally processing, physically behaving, and/or postured to conduct activities. The relative inefficiency of some systems to identify trainee 110 tendencies, behaviors, and deviations from ideal performance may inhibit the identification of what instructions, drills, or advice is most likely to resonate with the trainee 110 as well as inhibit the identification of what communication manner has the best chance of increasing the trainee's 110 proficiency in a task and/or accuracy of task performance.

It is noted that a trainee 110 may be any user of the training environment 100 and any number, and type, of constituent components, such as a sensor 122/124, computing device 130, or apparatus 140. Accordingly, the terms trainee and user may synonymously be used to describe various embodiments.

FIG. 2 illustrates a block representation of aspects of an example training assembly 200 that may be incorporated into the training environment 100 of FIG. 1. In accordance with various embodiments, a computing device 130 may compile sensor data into representations of one or more movements, actions, or behaviors of a trainee 110.

The processor 132 may convey such compiled sensor data to a trainee 110 via a graphical plotting of activity (solid line 222) compared to one or more plots (segmented line 224) corresponding with ideal activity for maximum performance for a specific task, action, or series of actions. That is, information derived from sensed trainee activity can be presented to the trainee 110 in graphical form, once compiled by the processor 132, compared to ideal athletic, or non-sporting task, activity. Such graphical comparison of actual behavior to ideal behavior may efficiently convey a relatively large amount of information. However, a trainee 110 may not efficiently translate the graphical comparison into practical changes, drills, or positions that will improve task completion performance over time.

Other embodiments may utilize the computing processor 132 to provide audible and/or visual checklist of ideal behavior element list 232 compared to the sensed behavior and activity of a trainee 110. In other words, the processor 132 may identify goals, elements, and other aspects of an ideal behavior, such as moving a ball, articulating a tool, performing a jump shot, lifting a weight, positioning equipment, racing a vehicle, or hitting a ball.

The identified aspects of an ideal behavior may be displayed, or spoken, to a trainee 110 as tasks that have been met (check mark), been missed (x mark), or yet to be achieved (question mark), as shown in list 232. Through the identification of ideal behavior aspects to be conducted by a trainee 110, overall behaviors, movements, and actions can be efficiently conveyed. However, a trainee 110 may not efficiently, or accurately, understand how to achieve certain identified ideal elements, which can correspond with inefficient growth, learning, or improvement through practice.

Embodiments of the computing device 130 utilize a processor 132 to capture aspects of an athlete's behavior and identify deviations from a predetermined standard stored in memory 134 accessible by the processor 132. Such identification of how behavior is different than a standard position, motion, or application of force can be characterized as visual feedback 242 that augments a picture, video, or series of pictures with text, arrows, circles, or other identifying marks to indicate where the athlete is not performing according to a standard.

Although the computer processor 132 may efficiently analyze a trainee's behavior and incorporate one or more identifiers to visual direct a trainee 110 to what aspects are different than ideal, such visual feedback 242 may be inefficient at conveying how to change to correct the identified issue. For instance, visual feedback 242 may convey where a trainee 110 is deficient, such as posture, arm movement, or timing of the application of force, but may be inefficient at indicating what an athlete/trainee 110 can do to improve performance. In other words, visual feedback 242 may identify what is wrong without indicating how the trainee 110 can reach the ideal task execution and/or performance. Indeed, some trainees 110 may understand visual feedback 242 well, but others may misunderstand, or not comprehend, what is needed to conduct ideal behavior for optimal execution and maximum performance.

In some embodiments, the computing device 130 may generate multiple different types of feedback for a trainee 110. As an example, the computing processor 132 may generate visual feedback 242 and graphical analytics 222/224 that may be selected by a trainee 110 or shown concurrently to the trainee 110. However, the diversity of feedback may be insufficient and/or inefficient at improving the task execution and/or performance of a trainee 110. It is contemplated that conventional feedback, such as graphical analytics, visual feedback 242, and checklist elements 232, may lack progressive actions or activities to gradually correct a trainee's behavior. Instead, feedback may simply show the differences in a trainee's behavior compared to an ideal standard, which may be challenging to correctly implement into some actions, behaviors, or body positions, particularly complex behaviors commonly utilized in tasks conducted in sports, and non-sports, activities, such as basketball, medical procedures, golf, equipment operation, or component assembly.

The use of a single standard for ideal behavior for a trainee 110 may add challenges to accurate implementation, despite efficient visual representation of a trainee's deviation from ideal behavior. That is, ideal task execution and performance may be different for different trainees 110 and may correspond with different postures, positions, motions, mental states, and movements to reach maximum possible performance of physical, and mental, capabilities. For instance, a single ideal standard for mental and/or physical behavior may not factor a trainee's capabilities due to body type, previous injury, stress level, current skill level, or environment. As such, the computing processor 132 may lack analysis and/or instruction to efficiently improve a trainee's performance and/or reaching a trainee's performance potential.

With visual feedback 242, it is contemplated that various alternative reality elements may be utilized to convey information to a trainee 110. For instance, augmented reality may introduce digital content to actual reality via goggles, screens, or computing devices. Similarly, virtual reality may replace portions of reality with digital content. In a different manner, holographic content may be project images into space and/or onto real surfaces. The ability to employ such a diverse variety of visual feedback 242 may provide different manners of communicating instruction, drills, and advice, but may also produce more complicated visual feedback 242 than if a single visual characteristic, such as video or holograms, were utilized. As such, greater visual feedback 242 options may degrade the effectiveness of the information conveyed if a communication option is not tailored to the trainee 110.

FIG. 3 is a block representation of portions of a training system 300 configured and operated in accordance with various embodiments. The training system 300 employs a headband assembly 310 onto which a variety of sensors 124 are attached in a manner to accurately, and efficiently, detect the real-time biometric and/or physiological conditions of the user/trainee 110. The sensors 124, along with any other sensors connected to the computing device 130 of the training system 300, may provide a variety of information about the physical and mental activity of the user/trainee 110 before, and during, a task, as represented by solid box 320. It is noted that a user/trainee 110 may be engaged in any number, and type, of tasks 320 individually, sequentially, or concurrently, such as playing a sport, operating equipment, or conducting a procedure.

With the identification of user/trainee 110 activity in preparing, or conducting, actions associated with completing a task 320 with one or more sensors 124, the computing device 130 may generate and/or execute a communication strategy that prescribes at least visual content to aid the user/trainee 110 in completing the task 320 in accordance with a predetermined, ideal standard. The visual content is not limited to a particular communication mode, such as holographic, augmented reality, or video, but the communication strategy may prescribe the concurrent, individual, or sequential activation of multiple different visual content components, such as augmented reality glass 330, mounted holographic projector 340, or stationary projector 350.

With the conveyance of digital content via augmented reality glass 330, reality is utilized as a background for digital content, which may provide efficient positioning and orientations for content relative to the task 320, including any equipment, tools, and sub-assemblies utilized during the task 320. However, augmented reality glass 330 may be cumbersome and/or misaligned with respect to the trainee's head 112 during use, which may degrade the effectiveness of digital content display. Hence, various embodiments may convey digital content with one or more holographic representations 342/352 that replace, or supplement, content displayed via augmented reality glass 330.

By mounting a visual content projector 340 on a trainee's head 112, a holographic representation 342 may provide similarly efficient positioning and orientation relative to a task 320 as content displayed via the augmented reality glass 330. Yet, the ability to display holographic content in space proximal to a task, tool, or body position engaged by the trainee 110 may provide three dimensional characteristics that augmented reality may not efficiently provide unless the trainee 110 moves the head 112. That is, holographic content 342 may animate, move, and adapt in three-dimensional space to convey information to the trainee 110 that corresponds with greater accuracy, efficiency, and/or proficiency than a two-dimensional video displayed on glasses, or on a screen.

The training system 300 may employ any number of stationary projectors 350 that may operate alone, or in concert with other visual content conveying components. It is contemplated that a stationary projector 350 may provide visual holographic content 352 on a surface, or object, that allows the user/trainee 110 to reliably see, and understand, the content being shown. Through the intelligent selection of visual content, and content display source, the training system 300 may convey information, advice, drills, and other instruction to the user/trainee 110 that increases the chance, and potentially quality, that the task 320 is completed in accordance with a predetermined order, timing, and operating parameters.

In a non-limiting example, holographic content 342/352 may convey one or characters and objects, such as professionals, robots, or fantasy characters, carrying out portions of the task 320 in accordance with predetermined parameters. As such, holographic content 342/352 may differ from traditional video content by providing three-dimensional sizing, proportions, and spacing, which may be particularly useful in trying to replicate movements, actions, positioning relative to equipment, such as bat, ball, tool, or control.

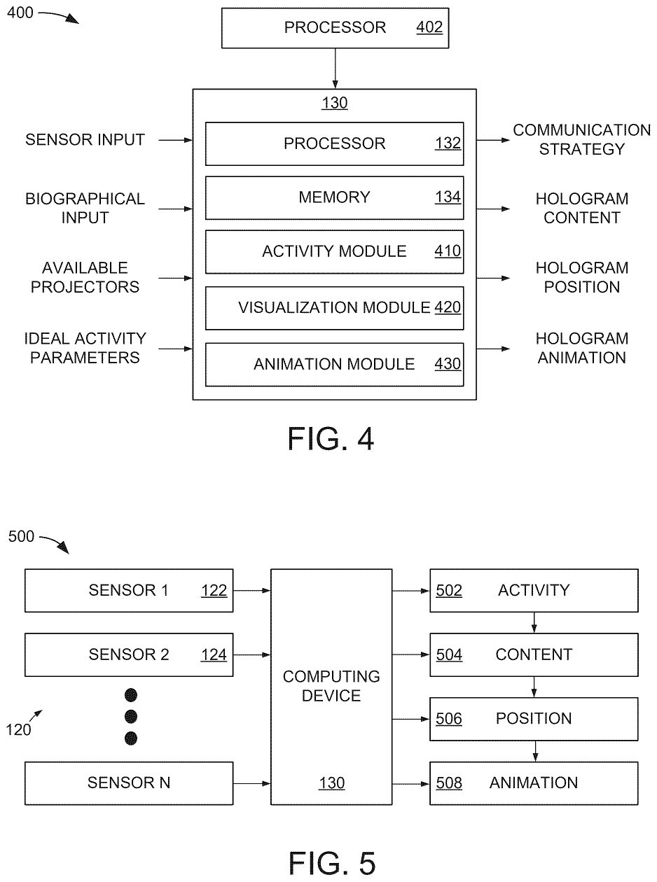

FIG. 4 illustrates a block representation of portions of a training system 400 that may be utilized in accordance with various embodiments to intelligently select, and convey, visual content to a user to the furtherance of a task, action, behavior, or process, such as task 320. The training system 400 may employ any number and type of computing devices 130 to provide intelligent collection, analysis, and translation of sensor data into digital content that aids in completion of at least one tasks 320 by a trainee 110 participating in a training environment 100. The computing device 130 may employ one or more processors 132 to translate assorted input information into a variety of determinations, strategies, and milestones that can be used to efficiently communicate with a trainee 110 and convey training instructions, information, and advice to improve the user's performance in completing a task action, behavior, or process.

While not limiting or required, various embodiments input at least data from sensors 120, biographical data about the subject trainee 110, a list of available digital content projectors, and ideal activity parameters to complete a task in order to generate a communication strategy and holographic configurations. The assorted input data and data generated by the local 132, or remote 402, processors may be temporarily, or permanently, stored in memory 134, which may make computations, analysis, and intelligent generation of holograms and communication strategy aspects more efficient than if a memory 134 was not utilized for data storage. The ability to utilize multiple processors 132/402, either local or remotely located, may provide robust computing capabilities that feed various operational modules. It is noted, however, that some embodiments utilize separate processors 132/402 for the respective operational modules of the computing device 130.

In accordance with various embodiments, the computing device 130 may have circuitry, such as application specific integrated circuits, chipsets, system-on-chip, or other programmable circuitry, that provide trainee 110 activity analysis, holographic content generation, formatting, visualization, spacing, and animation capabilities, as represented by the respective operational modules 410/420/430 shown in FIG. 4, It is noted that each module 410/420/430 is shown in block form for simplicity, but may include one or more circuits physically present in a local, or remote, computing device 130, such as a tablet, smartphone, laptop, or desktop computer, that operate to translate input signals into at least one decision, determination, or conclusion with respect to what, and how, training information is conveyed to a trainee 110.

Although the processor(s) 132/402 of the computing device 130 may operate alone to translate input data into assorted training determinations, such as training drills, instructions, guidance, meditation, statistics, and task information, various embodiments structurally configure the computing device 130 with separate circuitry directed to carrying out specific tasks alone, or with the aid of the available processors 132/402. Such task specific circuitry can be characterized as a module, but in no way limits the possible circuit configurations and operational components of the computing device 130 that may intelligently translate input data into task training communications. In other words, circuitry of the computing device 130 can operate alone, or in combination with other circuitry, to carry out data analysis, computations, determinations, and content generation.

The computing device 130 may have an activity module 410 directed at determining what task, or series of tasks that may be characterized as an activity, a trainee 110 is doing, or preparing to start doing, from the trainee's actions, behaviors, biometric indicators, and psychological state. The activity module 410 may input any sensor data over any length of time to identify that a trainee 110 is engaging in a task, preparing to engage in a task, or transitioning between related tasks. For instance, the activity module 410 may input the sensed position of a trainee's arm, equipment handled by the user, heart rate of the trainee, oxygen saturation of the trainee, and stress level of the trainee, along with any number of detected environmental conditions, such as temperature, humidity, elevation, and global position, to recognize, in real-time or predictively, that a task, or plurality of tasks, is undertaken by the trainee 110.

It is contemplated that any number, and type, of algorithms, such as machine learning, artificial intelligence, and other predictive computations, might be utilized by the activity module 410, and system processors 132/402, to efficiently determine what task a trainee may be engaging as well as potential subsequent actions, behaviors, and tasks. Such correlation of sensed trainee, and environmental, conditions with one or more tasks, actions, behaviors, and events may allow the computing device 130 to generate a communication strategy that prescribes at least timing, order, and placement of visual digital content to increase the chance of a trainee 110 accurately, safely, and efficiently completing a task, action, or process.

A communication strategy is not limited to a particular set of correlations between detected conditions and the display of visual content to a trainee, or user of a task training system. However, various embodiments of the training system 400 proactively generate one or more communication strategies to allow for the quick implementation of visual content prescriptions in response to detected, or predicted, user activity. That is, the computing device 130 may generate multiple communications strategies that prescribe different visual content selection, timing, order, and/or placement relative to a user in order to accommodate a diverse variety of encountered task engagements.

A communication strategy, in some embodiments, may prescribe an operational trigger, such as physical body position, engagement with a tool/equipment, movements, or brain activity associated with a mental state, to a selection of what visual content to display to the user, how to display the content, and when to display the content to increase efficiency, and proficiency, in task execution and performance. As a non-limiting example, a communication strategy may prescribe a hologram of a particular arm position to be displayed by a head-mounted holographic projector in response to a ball, or tool, being held by the trainee. As another example, a communication strategy may prescribe text instructions, or operational statistics, to be displayed via an augmented reality component in conjunction with an animated hologram of a professional engaging in the task from a stationary projector concurrently with the user in response to detected biometric and/or physiologic metrics.

The visual content selection, and placement, prescribed by a communication strategy may be computed, analyzed, and generated by a visualization module 420. Some embodiments employ the visualization module 420 to evaluate input data to determine what should be shown to a user, when the content should be shown relative to a task, and where the content should be shown. Such determinations may be reactive or predictive and may be based on speculative analytics, previously experienced model data, and past logged user conditions to provide holographic, and other visual content, configurations that give heightened chances for effectiveness in increasing task completion speed, accuracy, and safety.

The intelligent determination of what, when, and where visual content is to be displayed to a user relative to a task may include evaluation of how the visual content behaves while being displayed. That is, an animation module 430 may evaluate one or more potential holographic animations to determine if content effectiveness can be increased through implementation of one or more animations over time. Hence, the animation module 430 may operate in concert with the visualization module 420 to analyze how task completion instructions, advice, training, and guidance may be presented to a user in an effort to maximize task completion quality and efficiency. As an example result of the intelligent selection of holographic visual content, either as part of a communication strategy or not, the training system 400 may convey similar, or dissimilar, holographic content positioned at selected three-dimensional locations relative to the user and task being completed.

In accordance with various embodiments, the training system 400 may select, and/or prescribe, adaptations of visual content configurations in response to detected user, or environmental, conditions. For instance, a communication strategy may prescribe identification of visual content display being ineffective, such as not increasing task completion performance, and also prescribe alterations to visual content display to compensate, or correct, the identified ineffectiveness. The computing device 130 may utilize the assorted modules 410/420/430 to efficiently identify a user's progress in completing a task, such as milestone or sub-task completion, which may trigger progression of the display of visual content to improve task completion performance. Similarly, the training system 400 may efficiently identify and transition to different tasks with alterations to how, and potentially what, visual content is displayed.

FIG. 5 illustrates a block representation of portions of a training system 500 utilizing a computing device 130 in accordance with various embodiments. The system 500 employs a number of separate sensors 120, which may be stationary 122 or dynamic 124, to provide data and signals to the assorted circuitry of the computing device 130. Through the analysis of the sensed aspects of a user and/or user environment, the computing device 130, and specifically the activity module 410, may determine what tasks a user may be conducting as well as what visual content can be displayed to increase task completion performance.

As shown in FIG. 5, step 502 may provide user activity identification resulting from an evaluation of sensor 122/124 inputs by the computing device 130. Such identification may prompt the selection of visual content in step 504, which may be prescribed by one or more communication strategies. The content selection of step 504 may involve formatting visual content into a particular type and size for display from one or more visual components, such as an augmented reality component and/or holographic projector.

Sequentially, or concurrently, with the selection of the visual content in step 504 and the selection of the visual content position in step 506, the computing device 130 may determine what, if any, aspect of visual content is to move, or animate, over time in step 508. The evaluation of holographic animation in step 508 may be prescribed by a communication strategy or be prompted by sensed conditions associated with a user and/or the environment proximal a task being completed. It is noted that the computing device 130 may engage in any of the steps 502/504/506/508 shown in FIG. 5 at any time before, during, and after a task is completed. For instance, the computing device 130 may continuously, sporadically, routinely, or responsively evaluate and alter any aspect of visual content displayed to a user in response to information detected by one or more sensors 122/124.

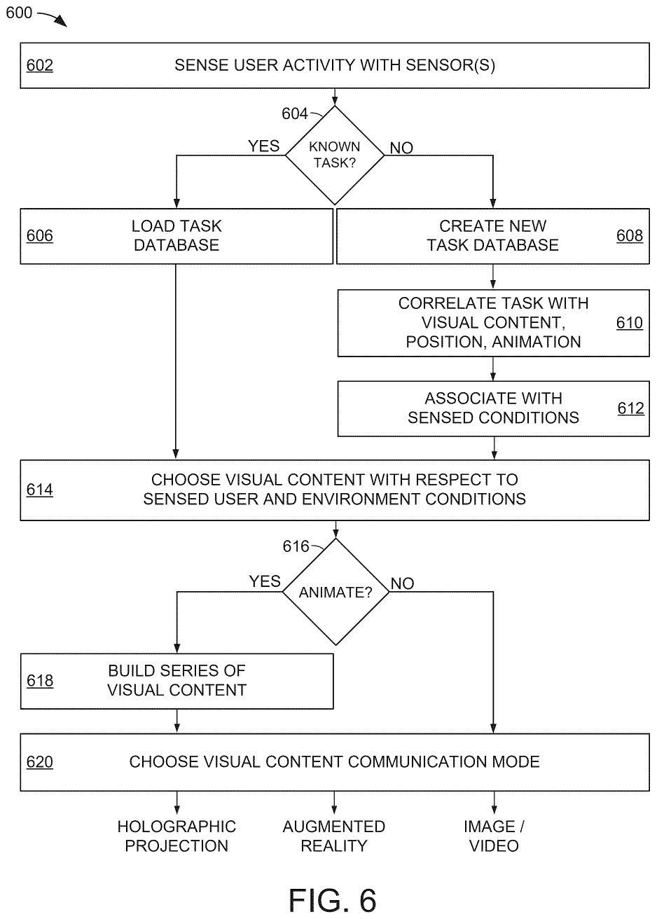

FIG. 6 is a flowchart of an example visualization routine 600 that may be performed by a training system, such as the systems 300/400/500 of FIGS. 3-5 in accordance with various embodiments. The visualization routine 600 may begin with the detection of user, or trainee, activity with one or more sensors, such as sensors worn by the user and separated from the user, in step 602. The sensed information may be processed by a computing device of the training system, such as a processor worn by the user, to determine, in decision 604, if the user activity correlates to a known task.

If the user is engaging in a known task, step 606 proceeds to load a task database that may include various information about the task, such as predetermined operational timing, metrics, and performance, as well as logical progressions of future user activity once the task is completed, such as repeating the task or transitioning to a known secondary task.

In the event the user activity and environmental conditions sensed in step 602 does not indicate a known task, decision 604 may create a new task database in step 608 that is populated by visual content, content position, and content animation configurations in step 610 before being associated with physical and/or mental conditions of a user/trainee in step 612 that prompt the generation and display of the visual content in response to sensed, or predicted, behavior, actions, and/or placement of aspects of a user's body, head, arms, legs, or hands.

Various embodiments of the correlation of visual content with a new task in step 610 and the association of a new task with sensed conditions in step 612 may involve speculative intelligence based on logged user activities and conditions over time. That is, step 610 and step 612 may employ one or more algorithms and/or correlation techniques to populate a database with what visual content may aid in completion of the new task, where the visual content may be positioned relative to a task and user, and whether animated visual content may improve user adherence to visual content guidance to task completion. Hence, a task database may have task actions, order, operational parameters, and timing that are correlated with assorted visual content, such as diagrams, holograms, statistics, lists, pictures, and directional indicators that promote task efficient, accurate, and safe task completion.

With a known task database loaded in step 606, or created in step 608, step 614 proceeds to choose visual content to display to the user based on detected information about the user and environmental conditions. For instance, step 614 may identify where the user is in regard to a progression towards task completion and prompts one or more visual content to display to the user to guide the user through the remaining progression. It is contemplated that step 614 may choose a number of different visual content to display to the user in succession, or concurrently, but such arrangement is not required.

While the chosen visual content may be shown to the user at any time, some embodiments evaluate, in decision 616 whether to animate the visual content. A determination that animation would aid in guidance of the user prompts step 618 to build a series of visual content that may be displayed in order to animate a hologram, augmented reality component, or video. The creation of animated content in step 618, or a determination that no animation is to be shown to the user from decision 616, allows step 620 to choose one or more communication modes for the visual content nominated for display. Although not limiting, step 620 may activate one or more holographic projectors, an augmented reality device, or a monitor to provide images, pictures, augmented reality, and holograms to the user, as prescribed.

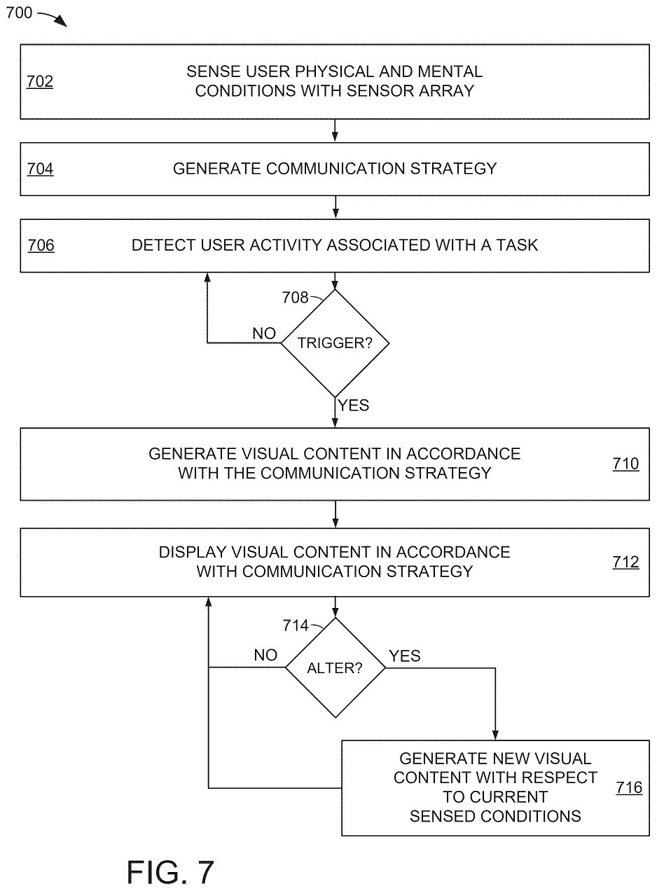

FIG. 7 illustrates a flowchart of a communication routine 700 that may be carried out by a training system in accordance with various embodiments. It is noted that the communication routine 700 may be conducted alone, or in combination with the visualization routine 600 of FIG. 6. Initially, the communication routine 700 may utilize a sensor array, such as garments worn by a user with integrated sensors, to detect the physical and mental conditions of a user in step 702. The sensed information pertaining to a user, and the user's proximal environment, may then be employed to generate a communication strategy in step 704.

Some embodiments of step 704 may identify, or intelligently speculate, as to the activity and/or activity sub-tasks a user is undertaking, or about to conduct. The generation of a communication strategy may proactively prescribe operational metrics, such as stress level, head position, arm position, user global location, body temperature, or eye gaze direction, to a progression of a task, or activity, towards completion. That is, a communication strategy may prescribe visual content that is pertinent to an identified user progression between task/activity initiation and completion. It is contemplated that the communication strategy prescribes a number of different visual content prompted by different encountered user/environmental conditions.

With a communication strategy generated, step 706 carries out the strategy by detecting user activity with one or more sensors to identify specific task/activity execution and progression. If sensed conditions from step 706 meet a threshold metric defined by the communication strategy, as evaluated in decision 708, step 710 follows the communication strategy to generate visual content intended to guide and aid the user in conducting aspects of a task, sub-task, or activity. In the event no operational trigger is encountered in decision 708, user activity is monitored in step 706 by one or more sensors.

Once visual content is generated in accordance with the communication strategy in step 710, step 712 activates one or more prescribed devices, such as a projector, augmented reality device, monitor, or display, to convey the visual content to the user. Such display of visual content may continue for any amount of time as the user conducts action, movements, and postures repeatedly, or individually. While the visual content is conveyed, decision 714 may evaluate if any aspect of the visual content is to be altered, either as prescribed by the communication strategy or in response to sensed user biometrics, such as stress, heart rate, or mental state.

Decision 714 may, in some embodiments, may evaluate detected activity from one or more sensor of a sensor array in comparison to one or more predetermined activity parameters, as shown in FIG. 4. Such evaluation may utilize one or more local processors 132 and remotely connected processors 402 to compare detected input from sensors to one or more known parameters to determine if content displayed to the trainee/user matches the position, actions, and behaviors corresponding to the known parameters. That is, a computing device 130 may monitor how a user/trainee reacts to displayed content to determine if the displayed content is providing optimal guidance, training, and direction to the trainee/user to accomplish a task, behavior, action, physical position, or series of movements that may constitute a process. By monitoring a user/trainee in real-time, the computing device 130 may efficiently alter the content and/or display to provide predetermined results, such as improve movement consistency, physical positioning of body parts, and performance results of a task.

Step 716 generates new visual content when prompted by decision 714. Such new visual content may be generated with current user conditions in mind, which may differ from the visual content prescribed by the communication strategy. However, step 716 may simply progress to new visual content prescribed by the communication strategy. The correlation of currently sensed user conditions may provide information about what visual content may be helpful to complete a task, or activity, in better conformance with ideal performance standards. For instance, step 716 may zoom into a hologram in response to detected frustration levels of the user after failure to perform a task action in accordance with a predetermined position, movement, force, and/or timing.

In accordance with some embodiments, a task training system, such as system 300/400/500, may detect a first condition, such as in step 602, of a user, such as trainee 110, with a sensor array, such as sensors 120, with the sensor array connected to a computing device, such as computing device 130. The computing device may generate a first training content, such as in step 710, in response to the detected first condition, such as in step 614. The generated content may be displayed to the user, as directed by the computing device, such as in step 712. The sensor array may be used to identify a reaction of the user in response to the first training content, such as in step 706, before determining a mismatch of the reaction to a predetermined activity parameter, such as in decision 714, and generating a second training content in response to the mismatch, such as in step 716. The second training content may be displayed to the user, as directed by the computing device, such as in step 712, prior to detecting a second condition of the user with the sensor array, such as in decision 714, and confirming the second training content matches the predetermined activity parameter, such as in decision 714.

In some aspects, a task training system may have a sensor array, such as sensors 120, connected to a computing device, such as computing device 130, and worn by a user, such as trainee 110. A first content display, such as holographic projector 340, may be connected to the computing device and worn by the user, as shown in FIG. 3. The computing device may detect a first condition of the user with the sensor array, such as in step 706, generate a first training content in response to the detected first condition, such as in step 710, and display the first training content to the user with the first content display, such as in step 712. The first content display may display a second training content generated by the computing device, such as in step 716, to the user in response to a reaction of the user identified by the sensor array, such as in decision 714. The second training content may differ from the first training content and may be generated by the computing device, such as in step 710, in response to a determination, by the computing device, that the reaction of the user failed to match a predetermined activity parameter, such as in decision 714. The computing device may confirm a second condition of the user, detected by the sensor array, conforms to the predetermined activity parameter, such as in decision 714, in response to the display of the second training content, such as in step 712.

Through the assorted embodiments of a training system, visual content may be selected and intelligently displayed to a user to aid in the performance of a task. The ability of a training system to efficiently detect user, and environmental, conditions allow for the display of visual content that has a relatively high likelihood of increasing task completion efficiency, accuracy, and safety. The use of intelligently generated holograms, and augmented reality components, may further convey task-specific information, advice, and instruction to a user that promotes heightened operational performance.

It is to be understood that even though numerous characteristics and advantages of various embodiments of the present disclosure have been set forth in the foregoing description, this description is illustrative only, and changes may be made in detail, especially in matters of structure and arrangements of parts within the principles of the present disclosure to the full extent indicated by the broad general meaning of the terms wherein the appended claims are expressed.

What is claimed is:

1. A method comprising:
detecting a first condition of a user with a sensor array, the sensor array connected to a computing device;
generating, with the computing device, a first training content in response to the detected first condition;
displaying the first training content to the user, as directed by the computing device;
identifying, with the sensor array, a reaction of the user in response to the first training content;
determining, with the computing device, a mismatch of the reaction to a predetermined activity parameter;
generating, with the computing device, a second training content in response to the mismatch;
displaying the second training content to the user, as directed by the computing device;
detecting a second condition of the user with the sensor array; and
confirming, with the computing device, the second training content matches the predetermined activity parameter.

2. The method of claim 1, wherein the first condition is conducting an action associated with a sport or non-sporting task.

3. The method of claim 1, wherein the first training content is displayed to the user via a holographic projector.

4. The method of claim 1, wherein the second training content is different than the first training content.

5. The method of claim 1, wherein the second training content is displayed to the user differently than the first training content.

6. The method of claim 5, wherein the second training content has a different formatting than the first training content.

7. The method of claim 5, wherein the second training content is displayed at a different position relative to the user than the first training content.

8. The method of claim 5, wherein the second training content is animated and the first training content is static.

9. The method of claim 5, wherein the second training content is displayed at a slower speed than the first training content.

10. The method of claim 1, wherein the second training content is generated in response to recognizing the user conducting a known task.

11. The method of claim 10, wherein the second training content is selected from a communication strategy created by the computing device.

12. The method of claim 11, wherein the communication strategy prescribes predetermined training content responses to user conditions detected by the sensor array.

13. The method of claim 12, wherein the predetermined training content responses change the first training content to the second training content to increase a proficiency in the known task.

14. The method of claim 12, further comprising evaluating, with the computing device, an effectiveness of the first training content in completing the known task;
determining, with the computing device, a failure of the first training content to achieve an operational milestone associated with the known task; and
altering, with the computing device, the first training content to the second training content to increase proficiency of the user in completing the known task.

15. A system comprising:
a sensor array connected to a computing device and worn by a user;
a first content display connected to the computing device and worn by the user;
wherein the computing device is operable to detect a first condition of the user with the sensor array, generate a first training content in response to the detected first condition, and display the first training content to the user with the first content display;
wherein the first content display is operable to display a second training content generated by the computing device to the user in response to a reaction of the user identified by the sensor array;
wherein the second training content differs from the first training content and is generated by the computing device in response to a determination, by the computing device, that the reaction of the user failed to match a predetermined activity parameter; and
wherein the computing device is operable to confirm a second condition of the user, detected by the sensor array, conforms to the predetermined activity parameter in response to the display of the second training content.

16. The system of claim 15, wherein the sensor array comprises a first sensor attached to a head of the user and a second sensor attached to a body of the user.

17. The system of claim 15, wherein the sensor array comprises a first sensor operable to move with the user and a second sensor operable to remain stationary with respect to the user.

18. The system of claim 15, wherein the computing device comprises a processor operable to generate the second training content in response to a calculation of an effectiveness of the first training content in causing the user to match the predetermined activity parameter and operable to alter the first training content to the second training content to increase proficiency of the user in repeatedly completing the predetermined activity parameter.

19. The system of claim 15, further comprising a second content display connected to the computing device, the second content display operable to display information to the user differently than the first content display.

20. The system of claim 19, wherein the first content display is operable as a holographic projector and the second content display is configured as an augmented reality headset worn by the user.
